(19) United States
(12) Patent Application Publication
(10) Pub. No.: US 2025/0128980 A1
(43) Pub. Date: Apr. 24, 2025

(54) RADIATION SHIELDING GLASS HAVING ZINC-BARIUM-BOROSILICATE COMPOSITION

(71) Applicant: GUROK HOLDING B.V., Amsterdam (NL)

(72) Inventors: Recep KURTULUS, Afyon (TR); Taner KAVAS, Afyon (TR)

(21) Appl. No.: 18/681,174

(22) PCT Filed: Dec. 2, 2022
(86) PCT No.: PCT/IB2022/061710

§ 371 Date: Feb. 5, 2024

(51) Int. Cl. C03C 4/08; C03C 3/093; C03C 3/095

(52) U.S. Cl. CPC C03C 4/087; C03C 3/093; C03C 3/095; C03C 2204/00

(57) ABSTRACT

Disclosed is a radiation shielding zinc-barium-borosilicate glass material produced from easily accessible, low-cost and abundantly available starting raw materials, particularly for X-rays and/or gamma rays and/or fast neutrons and/or the like, having unique glass compositions. In particular, disclosed is the use of sodium oxide (Na₂O), silicon dioxide (SiO₂), boron oxide (B₂O₃), calcium oxide (CaO), barium oxide (BaO), zinc oxide (ZnO), bismuth oxide (Bi₂O₃), gadolinium oxide (Gd₂O₃) and cerium oxide (CeO₂), which when mixed provides a satisfactory and effective shielding effect against X-rays and/or gamma rays and/or fast neutrons and/or the like.

### TECHNICAL FIELD

The invention relates to a radiation shielding glass comprising sodium oxide (Na₂O), silicon dioxide (SiO₂), boron oxide (B₂O₃), calcium oxide (CaO), barium oxide (BaO), zinc oxide (ZnO), bismuth oxide (Bi₂O₃), gadolinium oxide (Gd₂O₃) and cerium oxide (CeO₂) which can be used in the fields of aerospace and/or agriculture and/or sterilisation depending on the demand in the field of radiation shielding, in particular in areas such as medical diagnostic centres equipped with X-ray and/or PET/CT and similar equipment, with scattering emitted from high-level energy sources such as X-rays and/or gamma rays and/or neutrons and/or the like.

### KNOWN STATE OF THE ART

With the technological developments in recent years, the number of waves, rays and/or similar emitted from different sources such as electronic devices is increasing day by day. This situation can come to the extent that threatens human health in a negative way depending on the duration and dose of exposure. Especially high-energy ones, such as X-rays and/or gamma rays and/or neutrons and/or the like, have such harmful effects on human health that they pose the risk of directly breaking the main bonds of biological cells. However, it can also cause health problems in the form of DNA mutations, dry eyes and skin burns. In order to reduce and/or eliminate these harmful health consequences, numerous protective materials such as metallic lead, concrete and/or similar are used.

Lead materials, which are often preferred among the alternative materials preferred to overcome radiation, cause serious negative consequences on both human and environment due to its toxic effect. In addition, low neutron absorption capacity and lack of transparency are another shortcoming of lead-based materials.

When it comes to eliminating the destructive aspects of radiation-induced non-ionising emissions, heavy concrete-based materials with different heavy aggregate additions and varying thickness factors are widely used to reduce high-energy scattering such as X-rays and/or gamma rays and/or neutrons and/or the like. However, the main technical problems are compositional changes due to time, temperature and similar factors during application and phase formation, as well as the risk of crack formation during operation. At the same time, due to its opaque appearance, it is impossible to use in applications where visibility is essential.

Both metallic lead and heavy concrete materials are primary examples of known applications of the art. However, as mentioned, their use is limited because they do not provide a transparent appearance. In particular, the aforementioned materials cannot be used in the area of an inspection door opening, which is essential within the framework of the room design criteria. From this point of view, different types of glass with various oxide compounds are produced in order to reduce and/or eliminate the effects of high-energy scattering such as X-rays and/or gamma rays and/or neutrons and/or the like.

In order to reduce and/or eliminate the effects of high-energy scattering such as X-rays and/or gamma rays and/or neutrons and/or the like, a lead oxide-based glass material was first developed. The high density (9.53 g/cm³) provided by the lead oxide compound is aimed at damping the incident emission scattering. However, although technically successful glass has been produced, alternatives have come to the fore due to the toxic effect of lead oxide compound on both human health and environmental conditions.

In terms of alternative glass systems, although glass types such as tellerium oxide, germanium oxide, vanadium oxide based glass types have been investigated in the literature, they have not been transformed into commercial products. This is due to inaccessible sources of raw materials, their unaffordability in terms of cost and the fact that the technique is not considered reasonable within the scope of known production methods.

There are studies on radiation shielding materials in the literature.

The patent application numbered 2018/09709 is related to the radiation shielding Er₂O₃ doped borosilicate glass, which can be used as window glass or exterior cladding in buildings and on the screens of devices such as computers, mobile phones and TVs that emit radiation. Here, as a result of erbium oxide doping at variable rates, indicators of shielding performance were extracted and the doping with the best performance was found.

In the patent application numbered 2018/09707, radiation shielding CeO₂ doped borosilicate glass was given as an invention. As a result of cerium oxide doping at varying rates, indicators of shielding performance were extracted and the doping with the best performance was found.

European patent application numbered EP1939147A1 relates to a radiation shielding glass and a method for manufacturing it. The said glass composition contains 10% to 35% SiO₂, 55% to 80% PbO, 0% to 10% B₂O₃, 0% to 10% Al₂O₃, 0% to 10% SrO, 0% to 10% BaO, 0% to 10% Na₂O and 0% to 10% K₂O by weight and has a total light transmittance of 50% or more at 400 nm wavelength and 10 mm thickness. Another patent application, U.S. Pat. No. 10,035,725B₂, discloses X-ray and gamma-ray shielding glass and a method of manufacturing such glass. The glass composition in question contains 0-35% SiO₂, 60-70% PbO, 0-8% B₂O₃, 0-10% Al₂O₃, 0-10% Na₂O, 0-10% K₂O, 0-0.3% As₂O₃, 0-2% Sb₂O₃, 0-6% BaO; and 0.05-2% ZrO₂ by weight. However, there is no information on zinc barium borosilicate glass material in these documents.

In order to overcome the above-mentioned problems with alternative radiation shielding materials used commercially and conventionally in the art, there is a need for an alternative glass composition that is more cost-effective than readily available raw materials, that is protective against high-energy scattering such as X-rays and/or gamma rays and/or neutrons and/or the like, that has no harmful effects on humans and the environment.

As a result, due to the above-mentioned disadvantages and the inadequacy of the existing solutions, a development in the relevant technical field has become necessary.

### OBJECT OF THE INVENTION

The invention is inspired by the present invention and aims to solve the above-mentioned problems.

The primary object of the invention is to provide a lead oxide-free zinc barium borosilicate glass composition specially designed to protect against high-energy scattering such as X-rays and/or gamma rays and/or neutrons and/or the like by minimising the negative effects on the environment and human health caused by lead oxide-containing radiation shielding materials used in the art.

An object of the invention is to provide an improved transparent zinc barium borosilicate glass material which has no harmful effects on humans and the environment. Said glass material comprises bismuth oxide (Bi₂O₃), gadolinium oxide (Gd₂O₃) and cerium oxide (CeO₂).

A further object of the invention is to develop a glass material which uses easily accessible raw materials, which is highly cost-effective and highly amenable to forming methods.

For this purpose, instead of lead-based materials and/or glass systems and/or concretes with different aggregates that are constantly preferred, the production process for zinc barium borosilicate glass was applied by selecting the starting raw materials of colemanite, barite, silica sand, zinc oxide, soda ash, bismuth oxide, gadolinium oxide and cerium oxide. The use of colemanite, which is borate calcium, is selected due to its neutron capture and/or absorption and/or damping mediator properties.

In our invention, it is preferred to use barite, a mineral consisting of barium sulphate, for attenuating X-rays and/or gamma rays and/or neutrons and/or the like. In order to improve the optical properties or to improve the radiation damping (attenuation) capabilities, the use of zinc oxide is included. Silica sand, a source of silicon dioxide, is selected to provide the structure of the glass system. Soda ash consisting of sodium carbonate is also preferred to lower the melting point of the glass system of the present invention.

In order to fulfil the above-mentioned objects, the invention is a radiation shielding zinc-barium-borosilicate glass which allows a transparent appearance to be provided in different areas where radiation-induced ionizing rays will occur, particularly in medical diagnostic centres and research institutes, and which can also be used for the purpose of preventing harmful radiation from X-rays and/or gamma rays and/or fast neutrons and/or the like, characterized by comprising; adding gadolinium oxide (Gd₂O₃) and/or bismuth oxide (Bi₂O₃) and/or cerium oxide (CeO₂) into zinc-barium-borosilicate (ZnO—BaO—B₂O₃—SiO₂) glass powder.

The structural and characteristic features and all advantages of the invention will be more clearly understood by means of the FIGURES given below and the detailed description written by making references to these FIGURES, and therefore, the evaluation should be made by taking these FIGURES and detailed description into consideration.

### FIGURES TO HELP UNDERSTANDING THE INVENTION

FIG. 1 is a schematic view of the production process of the inventive radiation shielding zinc barium borosilicate glass material.

### DESCRIPTION OF PART REFERENCES

1. Raw material prescription
2. Weighing unit
3. Raw material mixer
4. Melting furnace
5. Forming mould
6. Annealing furnace
7. Glass Product

### DETAILED DESCRIPTION OF THE INVENTION

In this detailed description, preferred embodiments of an inventive radiation shielding zinc-barium-borosilicate glass (ZnO—BaO—B₂O₃—SiO₂) are described only for the purpose of a better understanding of the subject matter.

The invention is a radiation shielding zinc-barium-borosilicate glass which allows a transparent appearance to be provided in different areas where radiation-induced ionizing rays may occur, particularly in medical diagnostic centres and research institutes, and which may also be used to prevent harmful emissions from X-rays and/or gamma rays and/or fast neutrons and/or the like, a zinc-barium-borosilicate (ZnO—BaO—B₂O₃—SiO₂) glass comprising the addition of gadolinium oxide (Gd₂O₃) and/or bismuth oxide (Bi₂O₃) and/or cerium oxide (CeO₂). The glass in question is used in applications such as bone densitometry, mammography, dental x-ray, X-ray imaging, magnetic resonance (MR), PET/CT, gamma knife and in the fields of space, defence, food and agriculture and not limited to those mentioned.

The said radiation shielding glass; comprising 0.01-15 mol % Na₂O, 0.01-5 mol % MgO, 0.01-5 mol % Al₂O₃, 15-75 mol % SiO₂, 0.01-30 mol % B₂O₃, 0.01-13 mol % CaO, 0.01-35 mol % BaO, 0.01-2 mol % TiO₂, 0.01-5 mol % SrO, 0.01-15 mol % ZnO, 0.01-4 mol % Li₂O, 0.01-10.00 mol % Gd₂O₃, 0.01-10 mol % Bi₂O₃, 0.01-10 mol % CeO₂, 0.01-5 mol % Sb₂O₃ and 0.001-0.10 mol % Fe₂O₃ components as range values.

The inventive radiation shielding glass has a melting temperature value above 1000° C. and below 1400° C. and an annealing initial temperature value above 400° C. and below 700° C. It also has an annealing time in the range of 80 to 120 minutes.

The thickness of the inventive radiation shielding glass is in the range of 3 to 100 mm. The glass density is 3.25 g/cm3 and above, and the Young's modulus is 75 GPa and above. The diffractive index of the said radiation shielding glass is 1.76 and above. The coefficient of thermal expansion is at most 8.75×10−6/K.

The said radiation shielding glass shall have the following dimensions and numbers in terms of the number of gas inclusions (habbees, fissures, and/or freckles).
15 pieces/30 gram glass for 0.001 to 0.01 mm diameter,
10 pieces/30 gram glass for 0.01 to 0.1 mm diameter,
5 pieces/30 gram glass for diameters of −0.1 mm and above

The subject matter of the invention is a radiation shielding glass, has a 50% transmission rate and above at a wavelength of 400 nm and a thickness of at least 10 mm, and a 75% transmission rate and above at a wavelength of 550 nm and a thickness of at least 10 mm.

The radiation shielding glass of the invention has silica sand, quartz, quartzite, barite, barium carbonate, colemanite, urexite, soda ash, albite, limestone, dolomite, spodumene, sodium nitrate, sodium sulphate, zinc oxide, gadolinium oxide, gadolinium sulphate, bismuth oxide, bismuth nitrate, cerium oxide, antimony trioxide, strontium carbonate, anthracite, zinc selenite and cobalt oxide as the starting raw materials.

In order to prepare the glass blend, the chemical composition of the raw materials is very important. Accordingly, the invention utilises high purity raw materials having satisfactory chemical composition properties. High purity at this point means having at least 99.00% of the main component and a maximum of 1000 ppm Fe₂O₃. The raw materials are carefully weighed within limited tolerances. According to the predetermined quantity for each raw material, glass tolerances are set to a maximum of 0.01% of the weighed quantities.

Impurities such as Fe₂O₃ (iron oxide) and/or similar impurities (e.g. Cr₂O₃) contained in the raw materials used in the glass manufacturing process cause the problem such as colouring of melt or similar (e.g. gas bubbles) glass defects. The transparency of the glassware is important for effective radiation shielding, which controls the resulting colouring at iron oxide values. This means that iron oxide causes the natural colouration of the glass through a greenish tint, resulting in poor visibility. In order to produce glassware that can provide appropriate transparency, the amount of iron oxide should not exceed 1000 ppm.

In addition, a transparent glassware is at risk of visually revealing some defects, including scratches, bubbles or the like. In order to achieve a remarkable quality in glassware, it is important to remove imperfections.

Density is a critical parameter that is monitored in a specific way and is the result of the optimisation of the patent mixture in question. The higher the density of the glass system, the higher the performance of the shielding glass. The densities obtained for glass composition variations are generally considered to be greater than 2.75-3.00 g/cm³, preferably 3.00-3.25 g/cm³, more preferably 3.25-3.50 g/cm³ and best greater than 3.50 g/cm³. As a result of this study, it was determined that the densities of the glasses were greater than 3.25 g/cm³.

The radiation shielding glass material of the present invention contains a novel glass composition in molar percentages ranging from 0.01 to 15.00 mol % Na₂O, 0.01 to 5.00 mol % MgO, 0.01 to 5.00 mol % Al₂O₃, 15.00 to 75.00 mol % SiO₂, 0.01 to 30 mol % B₂O₃, 0.01 to 13 mol % CaO, 0.01 to 35 mol % BaO, 0.01 to 2.00 mol % TiO₂, 0.01 to 5.00 mol % SrO, 0.01 to 15.00 mol % ZnO, 0.01 to 4.00 mol % Li₂O, 0.01 to 10.00 mol % Gd₂O₃, 0.01 to 10.00 mol % Bi₂O₃, 0.01 to 10 mol % CeO₂, 0.01 to 5 mol % Sb₂O₃ and 0.001 to 0.10 mol % Fe₂O₃. In addition, the refining agent cerium oxide in the range of 100 and 5,000 ppm can be used to remove glass defects such as cords, bubbles or similar. No other toxic refiners such as arsenic trioxide or the like are preferred in the present invention. In addition, the amount of iron oxide, which naturally causes the greenish colour in the glassware and is also the cause of low visibility, is strictly controlled during the melting process of the raw material mixture.

Sodium dioxide is a component that increases the mouldability of the glass composition as well as lowering its melting point. The sodium dioxide content is from 0 to 15 mol %, preferably from 5 to 10 mol %, more preferably from 10 to 15 mol %. If the sodium dioxide content exceeds 15 mol %, the high temperature viscosity becomes uncontrollable, resulting in insufficient radiation blocking capability.

Silicon dioxide is the structure of the glass composition and is also the main net formation agent of the present invention. The content herein is 15 to 75 mol %, preferably 55 to 60 mol %, more preferably 60 to 75 mol %. If the silicon dioxide content is greater than 75 mol %, the melting point of the glass composition increases, which leads to an uncontrollable viscosity characteristic. On the contrary, if the amount of silicon dioxide is lower than 15 mol %, the net forming becomes thermally unstable.

Boron oxide is a component that not only lowers the melting point of the glass composition, but also increases the thermal stability of the glass structure by changing its structure accordingly under suitable conditions. The boron oxide content is between 0 and 30 mol %, preferably between 0.1 and 5 mol %, more preferably between 5 and 10 mol %. If the boron oxide content is much higher than 30 mole %, the thermally stable state of the glass article in question deteriorates.

Calcium dioxide is a component which increases the chemical resistance of the glass composition, in particular to water. The calcium oxide content is between 0 and 13 mol %, preferably between 0.1 and 4 mol %, more preferably between 4 and 13 mol %. If the calcium oxide content is greater than 13 mol %, the formability becomes difficult, resulting in an insufficient radiation barrier against X-rays and/or gamma rays and/or fast neutrons and/or the like.

Barium oxide is a preferred component for increasing the radiation ability of glass materials due to the high atomic number of barium elements. The barium oxide content is from 0 to 35 mol %, preferably from 0.1 to 15 mol %, more preferably from 15 to 35 mol %. When the barium oxide content exceeds 30 mol %, the glass becomes thermally unstable.

Zinc oxide is a component that improves the ability to form glass and also provides higher UV transparency. The zinc oxide content is from 0 to 15 mol %, preferably from 0.1 to 4 mol %, more preferably from 4 to 8 mol %, even more preferably from 8 to 12 mol %. When the zinc oxide content exceeds 15 mol %, the radiation shielding performance of the glass in question is adversely affected.

Gadolinium oxide is used as a barrier against X-rays and/or gamma rays and/or fast neutrons and/or the like. Due to its high density value, it improves radiation shielding properties. The content of gadolinium oxide is from 0 to 10 mol %, preferably from 0.1 to 1 mol %, more preferably from 1 to 3 mol %, more preferably from 3 to 6 mol %. If the gadolinium oxide content is greater than 10 mole %, the glass loses transparency in terms of colour.

Bismuth oxide is a component that improves the radiation protection performance of glass systems due to the high atomic number of bismuth elements. The bismuth oxide content is from 0 to 10 mol %, preferably from 0.1 to 1 mol %, more preferably from 1 to 3 mol %, even more preferably from 3 to 6 mol %. If the bismuth oxide content is greater than 10 mole %, the glass becomes thermally unstable.

Cerium oxide is a component used as a clarifying agent in the glass system. The cerium oxide content is 1,000 to 5,0000 ppm, preferably 1,000 to 3,000 ppm. If the cerium oxide content is less than 1,000 ppm, insufficient refining of the glassware occurs, resulting in the inclusion of bubbles by the glassware.

Up to 10 mol % of any of the other components (e.g. Li₂O, K₂O) may be added as long as the properties of the glass are not impaired.

### Glass Examples of the Invention

In a practical embodiment of an improved glass composition specifically designed for the attenuation of X-rays and/or gamma rays and/or fast neutrons and/or the like, the following blend mixtures are prepared in molar percentages. These blends may vary according to the chemical properties of the raw materials selected within the scope of the present invention. The utilisation of the raw materials in terms of the quantities obtained, both chemically and physically, is variable within predetermined tolerances.

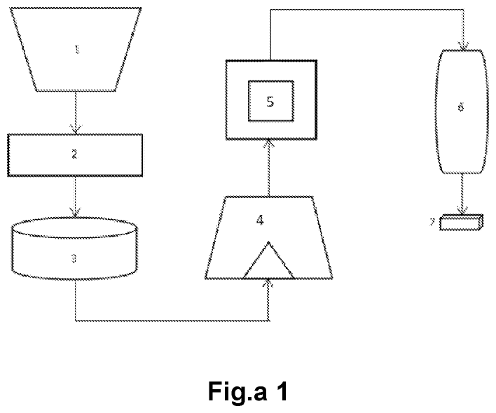

FIG. 1 shows the production process diagram. Firstly, the selected raw materials are prepared in such a way that they have the glass composition listed in each different application and sub-prescription. Weighing is carried out depending on the mentioned tolerance percentage. After weighing each compound, the mixing process is carried out by means of a mill and/or a mechanical mixer in a dry environment with alumina balls in a porcelain container for 15 to 60 minutes at a rotation speed range of 250 to 500 rpm in order to form a homogeneous mixture. After obtaining the homogeneous mixture, the prepared glass stacks are melted in an electric resistance lift melting furnace and/or in a gold-platinum alloy crucible without any atmospheric control. Any temperature value between 100° and 1400° C. can be selected for the melting temperature. The holding time at the melting temperature is 60 to 180 minutes. As soon as the glass melt is obtained and the waiting time is over, preferably the glass melt is immediately poured into a graphite mould or placed in a gold-platinum alloy crucible for 5 to 10 minutes at room temperature. The glass product obtained by both methods is then taken either together with the mould containing the glass melt or from the gold-platinum alloy crucible and placed in an annealing furnace heated to any temperature between 40° and 700° C. for stress relief annealing for any time between 80 and 120 minutes, and after the completion of the waiting period, the glass product is removed from the annealing vessel and/or furnace to obtain the final glass product.

In table 1 below, Example 1: A glass composition for effectively blocking radiation such as X-rays and/or gamma rays and/or fast neutrons and/or the like is provided. The code OR represents the basic recipe. The code BA indicates an increased amount of barium oxide (BaO). The BO code is associated with an increased amount of boron oxide (B₂O₃). Increasing both BaO and B₂O₃ improves the damping ability of the basic glass recipe, OR glass, against X-rays and/or gamma rays and/or fast neutrons and/or the like.

TABLE 1
Example 1: A glass composition for effectively blocking radiation such
as X-rays and/or gamma rays and/or fast neutrons and/or the like

| | OR | BA | BO |
|---|---|---|---|
| Na₂O | 6.31 | 6.60 | 6.24 |
| SiO₂ | 59.13 | 54.92 | 55.33 |
| B₂O₃ | 10.15 | 10.61 | 12.24 |
| CaO | 8.55 | 8.95 | 10.26 |
| BaO | 9.31 | 11.96 | 9.15 |
| ZnO | 4.35 | 4.55 | 4.27 |
| MgO | 1.31 | 1.38 | 1.57 |
| Al₂O₃ | 0.17 | 0.17 | 0.17 |
| SrO | 0.69 | 0.83 | 0.73 |
| Fe₂O₃ | 0.03 | 0.03 | 0.04 |
| Intensity (g/cm³) | 3.1101 | 3.2017 | 3.1142 |

Firstly, the selected raw materials are prepared in such a way that they have the glass composition listed in each different application and sub-prescription. Weighing is performed depending on the tolerance percentage mentioned. After weighing each compound, the mixing process is carried out by means of a mill and/or a mechanical mixer in a dry medium with alumina balls in a porcelain container for 15 to 60 minutes at a rotation speed range of 250 to 500 rpm in order to form a homogeneous mixture. After obtaining the homogenous mixture, the prepared glass stacks are melted in a gold-platinum alloy crucible in an electric resistance box type and/or lift melting furnace without any atmospheric control. The melting temperature is any temperature between 100° and 1400° C. As a waiting time at the melting temperature, any temperature value between 60 and 180 minutes is selected. As soon as the glass melt is obtained and the waiting time of the melt is over, preferably the glass melt is immediately poured into a graphite mould or kept in a gold-platinum alloy crucible at room temperature for 5 to 10 minutes to obtain a glass product. The glass product obtained by both methods is then either taken from the mould with the glass melt or from the gold-platinum alloy crucible and placed in an annealing furnace heated to any temperature between 40° and 700° C. for stress relieving annealing for any period between 80 and 120 minutes, after completion of the waiting time, the glass product is removed from the annealing vessel and/or furnace and the final glass product is successfully obtained.

Radiation shielding glass, have a linear attenuation coefficient value of 0.217 cm−1 and above at 662 keV energy level; Linear attenuation coefficient value of 0.155 cm−1 and above at 1173 keV energy level; linear attenuation coefficient value of 0.150 cm−1 and above at an energy level of 1332 keV for example 1 concrete components.

In table 2 below, Example 2: A glass composition for effectively blocking radiation such as X-rays and/or gamma rays and/or fast neutrons and/or the like is given. The code BB represents the basic prescription. The code BBGd indicates the amount of gadolinium oxide (Gd₂O₃) added. The code BBBi indicates the amount of bismuth oxide (Bi₂O₃) added. The code BBCe indicates the amount of cerium oxide (CeO₂) added. The addition of Gd₂O₃, Bi₂O₃ and CeO₂ improves the damping ability of the basic glass prescription BB glass against X-rays and/or gamma rays and/or fast neutrons and/or the like.

TABLE 2
Example 2: A glass composition for effectively blocking radiation such
as X-rays and/or gamma rays and/or fast neutrons and/or the like

| | BB | BBGd | BBBi | BBCe |
|---|---|---|---|---|
| Na₂O | 6.28 | 6.23 | 6.24 | 6.16 |
| SiO₂ | 52.82 | 52.31 | 52.43 | 51.76 |
| B₂O₃ | 12.28 | 12.17 | 12.19 | 12.04 |
| CaO | 10.34 | 10.24 | 10.26 | 10.14 |
| BaO | 11.33 | 11.22 | 11.24 | 11.10 |
| ZnO | 4.31 | 4.26 | 4.27 | 4.22 |
| MgO | 1.59 | 1.57 | 1.57 | 1.55 |
| Al₂O₃ | 0.17 | 0.17 | 0.17 | 0.17 |
| SrO | 0.84 | 0.83 | 0.83 | 0.82 |
| Fe₂O₃ | 0.04 | 0.04 | 0.04 | 0.04 |
| Gd₂O₃ | 0.00 | 0.96 | 0.00 | 0.00 |
| Bi₂O₃ | 0.00 | 0.00 | 0.76 | 0.00 |
| CeO₂ | 0.00 | 0.00 | 0.00 | 2.00 |
| Intensity (g/cm³) | 3.1858 | 3.2248 | 3.2270 | 3.2650 |

Firstly, the selected raw materials are prepared in such a way that they have the glass composition listed in each different application and sub-prescription. Weighing is performed depending on the tolerance percentage mentioned. After weighing each compound, the mixing process is carried out by means of a mill and/or a mechanical mixer in a dry environment with alumina balls in a porcelain container for 15 to 60 minutes at a rotation speed range of 250 to 500 rpm in order to form a homogeneous mixture. After obtaining the homogeneous mixture, the prepared glass stacks are melted in an electric resistance lift melting furnace and/or in a gold-platinum alloy crucible without any atmospheric control. The melting temperature is selected any temperature between 100° and 1400° C. The waiting time at the melting temperature is selected between 160 and 180 minutes. As soon as the glass melt is obtained and the waiting time of the melt is over, preferably the glass melt is immediately poured into a graphite mould or kept in a gold-platinum alloy crucible at room temperature for 5 to 10 minutes to obtain a glass product. The glass product obtained by both methods is then either taken from the mould with the glass melt or from the gold-platinum alloy crucible and placed in an annealing furnace heated to any temperature between 40° and 700° C. for stress relieving annealing for any time between 80 and 120 minutes, after completion of the waiting time, the glass product is removed from the annealing vessel and/or furnace and the final glass product is successfully obtained.

The inventive radiation shielding glass has a linear attenuation coefficient value of 0.254 cm−1 and above at 662 keV energy level; a linear attenuation coefficient value of 0.175 cm−1 and above at 1173 keV energy level; a linear attenuation coefficient value of 0.165 cm−1 and above at 1332 keV energy level for the embodiments of example 2.

In table 3 below, example 3: A glass composition for effectively blocking radiation such as X-rays and/or gamma rays and/or fast neutrons and/or the like is given. The codes BBGd1, BBGd2 and BBGd3 represent increasing amounts of gadolinium oxide (Gd₂O₃). Increasing Gd₂O₃ improves the damping ability against X-rays and/or gamma rays and/or fast neutrons and/or the like.

TABLE 3
example 3: A glass composition for effectively blocking radiation such
as X-rays and/or gamma rays and/or fast neutrons and/or the like

| | BBGd1 | BBGd2 | BBGd3 |
|---|---|---|---|
| Na₂O | 6.54 | 6.89 | 7.28 |
| SiO₂ | 48.91 | 45.14 | 40.92 |
| B₂O₃ | 12.78 | 13.46 | 14.22 |
| CaO | 10.76 | 11.33 | 11.97 |
| BaO | 11.79 | 12.41 | 13.11 |
| ZnO | 4.48 | 4.71 | 4.98 |
| MgO | 1.65 | 1.74 | 1.84 |
| Al₂O₃ | 0.17 | 0.18 | 0.19 |
| SrO | 0.87 | 0.92 | 0.97 |
| Fe₂O₃ | 0.04 | 0.04 | 0.04 |
| Gd₂O₃ | 2.01 | 3.17 | 4.48 |
| Intensity (g/cm³) | 3.3017 | 3.3867 | 3.4811 |

The linear attenuation coefficient (u) values obtained for Example 1, Example 2 and Example 3 are given in tables 4, 5 and 6 in cm−1 units. Three different gamma ray energy levels 662, 1173 and 1332 keV were selected as sample energy levels. Within the measurement method, gamma-ray spectroscopic analysis was used. NaI was used as a detector. Co60 and Cs137 were selected as radiation sources.

TABLE 4
Linear attenuation loss (μ) values (cm⁻¹)
at 662, 1173 and 1332 keV for example 1.

| Sample Name | 662 keV | 1173 keV | 1332 keV |
|---|---|---|---|
| OR | 0.217 | 0.155 | 0.150 |
| BA | 0.219 | 0.161 | 0.157 |
| BO | 0.222 | 0.166 | 0.164 |

TABLE 5
Linear attenuation loss (μ) values (cm⁻¹)
at 662, 1173 and 1332 keV for example 2

| Sample Name | 662 keV | 1173 keV | 1332 keV |
|---|---|---|---|
| BB | 0.254 | 0.175 | 0.165 |
| BBGd | 0.277 | 0.191 | 0.166 |
| BBBi | 0.290 | 0.197 | 0.166 |
| BBCe | 0.296 | 0.201 | 0.168 |

TABLE 6
Linear attenuation coefficient (μ) values
(cm⁻¹) at 662, 1173 and 1332 keV for example 3

| Sample Name | 662 keV | 1173 keV | 1332 keV |
|---|---|---|---|
| BBGd1 | 0.302 | 0.206 | 0.171 |
| BBGd2 | 0.315 | 0.213 | 0.173 |
| BBGd3 | 0.327 | 0.219 | 0.180 |

1. A radiation shielding zinc-barium-borosilicate glass which allows a transparent appearance to be provided in different areas where radiation-induced ionizing rays will occur, particularly in medical diagnostic centres and research institutes, and which can also be used to prevent harmful radiation from X-rays and/or gamma rays and/or fast neutrons and/or the like, wherein the glass comprises an addition of gadolinium oxide (Gd₂O₃) and/or bismuth oxide (Bi₂O₃) and/or cerium oxide (CeO₂) to zinc-barium-borosilicate (ZnO—BaO—B₂O₃—SiO₂) glass powder.

2. The radiation shielding zinc-barium-borosilicate glass according to claim 1, comprising components in range values of 0.01-15 mol % Na₂O, 0.01-5 mol % MgO, 0.01-5 mol % Al₂O₃, 15-75 mol % SiO₂, 0.01-30 mol % B₂O₃, 0.01-13 mol % CaO, 0.01-35 mol % BaO, 0.01-2 mol % TiO₂, 0.01-5 mol % SrO, 0.01-15 mol % ZnO, 0.01-4 mol % Li₂O, 0.01-10.00 mol % Gd₂O₃, 0.01-10 mol % Bi₂O₃, 0.01-10 mol % CeO₂, 0.01-5 mol % SB₂O₃ and 0.001-0.10 mol % Fe₂O₃.

3. The radiation shielding zinc-barium-borosilicate glass according to claim 1, used in applications such as bone densitometry, mammography, dental x-ray, X-ray imaging, magnetic resonance imaging (MRI), PET/CT, gamma knife and in the fields of space, defence, food and agriculture, and not limited to those mentioned.

4. The radiation shielding zinc-barium-borosilicate glass according to claim 1, wherein the Fe₂O₃ and Cr₂O₃ components have values of 1000 ppm or less.

5. The radiation shielding zinc-barium-borosilicate glass according to claim 1, having a melting temperature above 1000° C. and below 1400° C.

6. The radiation shielding zinc-barium-borosilicate glass according to claim 1, having an annealing initial temperature above 400° C. and below 700° C.

7. The radiation shielding zinc-barium-borosilicate glass according to claim 1 wherein an annealing time is in the range of 80 to 120 minutes.

8. The radiation shielding zinc-barium-borosilicate glass according to claim 1, wherein the glass thickness is in the range of 3 to 100 mm.

9. The radiation shielding zinc-barium-borosilicate glass according to claim 1, comprising 15 pieces/30 grams of glass for a diameter of 0.001 to 0.01 mm, 10 pieces/30 grams of glass for a diameter of 0.01 to 0.1 mm, and 5 pieces/30 grams of glass for a diameter of 0.1 mm and above, in terms of the number of gas inclusions (blisters and/or bubbles).

10. The radiation shielding zinc-barium-borosilicate glass according to claim 1, wherein the glass density is 3.25 g/cm³ and above.

11. The radiation shielding zinc-barium-borosilicate glass according to claim 1, wherein the Young's modulus value is 75 GPa and above.

12. The radiation shielding zinc-barium-borosilicate glass according to claim 1, wherein the refractive index is 1.76 and above.

13. The radiation shielding zinc-barium-borosilicate glass according to claim 1, having a transmission of 50% or above at a wavelength of 400 nm and a thickness of at least 10 mm.

14. The radiation shielding zinc-barium-borosilicate glass according to claim 1, having a transmission of 75% or above at a wavelength of 550 nm and a thickness of at least 10 mm.

15. The radiation shielding zinc-barium-borosilicate glass according to claim 1, having a coefficient of thermal expansion of not more than 8.75×10⁻⁶/K.

16. The radiation shielding zinc-barium-borosilicate glass according to claim 1, having a linear attenuation coefficient value of 0.217 cm⁻¹ and above at the 662 keV energy level for the components Na₂O, SiO₂, B₂O₃, CaO, BaO, ZnO, MgO, Al₂O₃, SrO and Fe₂O₃.

17. The radiation shielding zinc-barium-borosilicate glass according to claim 1, having a linear attenuation coefficient value of 0.155 cm⁻¹ and above at an energy level of 1173 keV for the components Na₂O, SiO₂, B₂O₃, CaO, BaO, ZnO, MgO, Al₂O₃, SrO and Fe₂O₃.

18. The radiation shielding zinc-barium-borosilicate glass according to claim 1, having a linear attenuation coefficient value of 0.150 cm⁻¹ and above at an energy level of 1332 keV for the components Na₂O, SiO₂, B₂O₃, CaO, BaO, ZnO, MgO, Al₂O₃, SrO and Fe₂O₃.

19. The radiation shielding zinc-barium-borosilicate glass according to claim 1, having a linear attenuation coefficient value of 0.254 cm⁻¹ and above at the 662 keV energy level for the components Na₂O, SiO₂, B₂O₃, CaO, BaO, ZnO, MgO, Al₂O₃, SrO, Fe₂O₃, Gd₂O₃, Bi₂O₃ and CeO₂.

20. The radiation shielding zinc-barium-borosilicate glass according to claim 1, having a linear attenuation coefficient value of 0.175 cm⁻¹ and above at the 1173 keV energy level for the components Na₂O, SiO₂, B₂O₃, CaO, BaO, ZnO, MgO, Al₂O₃, SrO, Fe₂O₃, Gd₂O₃, Bi₂O₃ and CeO₂.

21. The radiation shielding zinc-barium-borosilicate glass according to claim 1, having a linear attenuation coefficient value of 0.165 cm⁻¹ and above at the 1332 keV energy level for the components Na₂O, SiO₂, B₂O₃, CaO, BaO, ZnO, MgO, Al₂O₃, SrO, Fe₂O₃, Gd₂O₃, Bi₂O₃ and CeO₂.

22. The radiation shielding zinc-barium-borosilicate glass according to claim 1, having a linear attenuation coefficient value of 0.302 cm⁻¹ and above at the 662 keV energy level for the components Na₂O, SiO₂, B₂O₃, CaO, BaO, ZnO, MgO, Al₂O₃, SrO, Fe₂O₃ and Gd₂O₃.

23. The radiation shielding zinc-barium-borosilicate glass according to claim 1, having a linear attenuation coefficient value of 0.206 cm⁻¹ and above at the 1173 keV energy level for the components Na₂O, SiO₂, B₂O₃, CaO, BaO, ZnO, MgO, Al₂O₃, SrO, Fe₂O₃ and Gd₂O₃.

24. The radiation shielding zinc-barium-borosilicate glass according to claim 1, having a linear attenuation coefficient value of 0.171 cm⁻¹ and above at the 1332 keV energy level for the components Na₂O, SiO₂, B₂O₃, CaO, BaO, ZnO, MgO, Al₂O₃, SrO, Fe₂O₃ and Gd₂O₃.

25. The radiation shielding zinc-barium-borosilicate glass according to claim 1, comprising silica sand, quartz, quartzite, barite, barium carbonate, colemanite, ulexite, soda ash, albite, limestone, dolomite, spodumene, sodium nitrate, sodium sulphate, zinc oxide, gadolinium oxide, gadolinium sulphate, bismuth oxide, bismuth nitrate, cerium oxide, antimony trioxide, strontium carbonate, anthracite, zinc selenite and cobalt oxide as starting raw materials.
